(19) United States
(12) Patent Application Publication
(10) Pub. No.: US 2021/0180166 A1
(43) Pub. Date: Jun. 17, 2021

(54) ALLOY STRUCTURE HAVING A LOW MAGNESIUM CONTENT SURFACE

(71) Applicant: AMULAIRE THERMAL TECHNOLOGY, INC., NEW TAIPEI CITY (TW)

(72) Inventors: CHING-MING YANG, NEW TAIPEI CITY (TW); TZE-YANG YEH, New Taipei City (TW); CHUN-LUNG WU, New Taipei City (TW)

(21) Appl. No.: 16/713,793

(22) Filed: Dec. 13, 2019

(51) Int. Cl. C22F 1/04; C22F 1/02; C22C 21/00

(52) U.S. Cl. CPC C22F 1/04; C22C 21/00; C22F 1/02

(57) ABSTRACT

An alloy structure having a low magnesium content surface includes an alloy layer having an original magnesium content and a magnesium-deficient layer formed on the alloy layer, and the magnesium-deficient layer has a low magnesium content surface.

### FIELD OF THE DISCLOSURE

The present disclosure relates to an alloy structure, and more particularly to an alloy structure having a low magnesium content surface.

### BACKGROUND OF THE DISCLOSURE

Aluminum alloy is the most widely used metal material in industrial application. Aluminum alloy has the advantages of low density, high strength, high thermal conductivity, and good processability. With the application of aluminum alloys in the fields of aerospace, automotive, and machinery manufacturing, demands on the brazeability of aluminum alloys continue to increase, and the quality of brazing would directly affect the use of relevant components.

The main element that provides a strengthening effect in aluminum alloys is magnesium (Mg). However, excess magnesium content in aluminum alloys may be one of the reasons that causes poor brazing, which leads to inconsistent yield rates of the joint.

In view of this, the inventor of the present disclosure has been engaged in the development and design of related products for years, and in response to the above-mentioned inadequacies, the present disclosure provides an alloy structure having a low magnesium content surface that can effectively improve on the inadequacies with a more sensible design.

### SUMMARY OF THE DISCLOSURE

In response to the above-referenced technical inadequacies, the present disclosure provides an alloy structure having a low magnesium content surface.

In one aspect, the present disclosure provides an alloy structure having a low magnesium content surface, including: an original magnesium-content layer; and a magnesium-deficient layer formed on the original magnesium-content layer, in which the magnesium-deficient layer has a low magnesium content surface.

In certain embodiments, the thickness of the magnesium-deficient layer is at least greater than 10 μm.

In certain embodiments, the original magnesium-content layer and the magnesium-deficient layer are made of a magnesium-containing aluminum alloy, and the magnesium content of the magnesium-deficient layer is less than the magnesium content of the original magnesium-content layer.

In certain embodiments, the low magnesium content surface of the magnesium-deficient layer is formed by removing the surface of the heat-treated aluminum alloy.

Therefore, the present disclosure provides an alloy structure having a low magnesium content surface, which includes an original magnesium-content layer and a magnesium-deficient layer formed on the alloy layer. Furthermore, the magnesium-deficient layer has a low magnesium content surface, which strengthens the brazeability of the alloy and improves the yield rate of the joint.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of the alloy structure having a low magnesium content surface of the present disclosure.

FIG. 2 is a schematic view of treatment method of an alloy surface of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

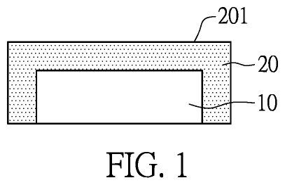

Referring to FIG. 1, an embodiment of the present disclosure provides an alloy structure having a low magnesium content surface, as shown in FIG. 1, the alloy structure having a low magnesium content surface of the present disclosure includes an alloy layer 10 having an original magnesium content and a magnesium-deficient layer 20 formed on the alloy layer 10, in which the magnesium-deficient layer has a low magnesium content surface, which strengthens the brazeability of the alloy and improves the yield rate of the joint.

In this embodiment, the original magnesium-content layer 10 is an aluminum alloy with Mg, a magnesium alloy, or a titanium alloy, but the present disclosure is not limited thereto.

In this embodiment, the magnesium-deficient layer 20 and the original magnesium-content layer 10 are integrally formed. Specifically, the low magnesium content surface 201 of the magnesium-deficient layer 20 is formed by removing the surface of the vacuum heat-treated aluminum alloy. Moreover, the magnesium content of the magnesium-deficient layer 20 is less than the magnesium content of the original magnesium-content layer 10.

Further, the aluminum alloy used to make the alloy structure having a low magnesium content surface may include elements such as silicon, copper, lead, aluminum, manganese, nickel, iron, tin, magnesium and others, and unavoidable impurities. The so-called unavoidable impurities are substances that are unavoidably mixed in the raw materials, but do not affect the characteristics of the aluminum alloy, and therefore are regarded as acceptable impurities. The silicon element can be used to increase the strength of the aluminum alloy, the copper element can be used to enhance the hardness of the aluminum alloy, and the lead element can be used to enhance the workability of the aluminum alloy.

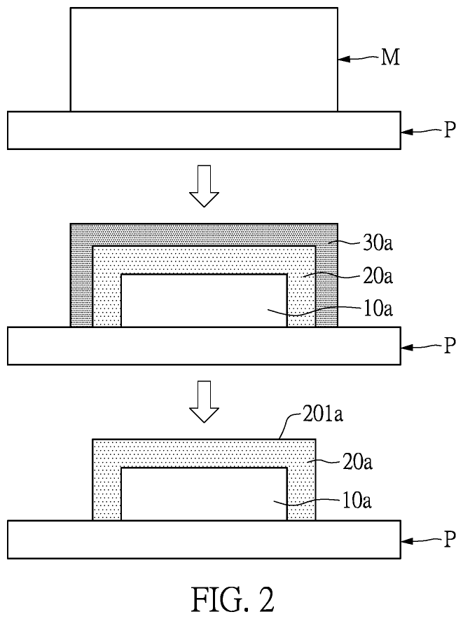

Moreover, referring to FIG. 2, the alloy structure having a low magnesium content surface of the present disclosure can be obtained by an alloy surface treatment method, which mainly includes the following steps:

(1) Vacuum heat treatment: providing an aluminum alloy M on a fixture P and placing it in a vacuum furnace (not shown in the figure), raising the temperature under a heating rate 15° C./min., preferably heating the temperature to 500° C.˜600° C. (if another alloy is used, the temperature is based on the temperature at which the elements on the surface of the alloy becomes active), maintaining the temperature for a temperature-maintained time of >30 min., and then cooling for a cooling time of <120 min. The vacuum degree of the vacuum heat treatment is preferably <10⁻⁴ torr. In addition, the aluminum alloy M can also be placed on the fixture P and placed in a protective atmosphere furnace (not shown in the figure), and heated in a protective atmosphere (such as N₂, Ar), the oxygen content preferably being <50 ppm.

(2) Obtaining an alloy structure including a magnesium-rich layer 30a having a high magnesium content on the surface, a magnesium-deficient layer 20a with a thickness of >10 μm, and an original magnesium-content layer 10a. The magnesium content of the magnesium-rich layer 30a is 0.1-100%. In addition, the thickness of the magnesium-deficient layer 20a depends on the vacuum degree and the temperature-maintained time and maintained temperature of the vacuum heat treatment. The thickness of the magnesium-deficient layer 20a is thicker when the vacuum degree is higher, the temperature-maintained time is longer and the maintained temperature is higher. Further, in the alloy structure, an area from the lower edge of the magnesium-deficient layer 20a to the place where the magnesium-deficient layer 20a contacts the fixture P is the aluminum alloy with the original magnesium content, that is, surfaces of the aluminum alloy that are not exposed and in contact with vacuum will not form the magnesium rich layer 30a nor the magnesium deficient layer 20a.

(3) Surface reduction treatment: the obtained alloy structure is subjected to a surface reduction treatment to reduce the magnesium-rich layer 30a, and a brazing surface with low magnesium content can be obtained afterward. The brazing surface is a low magnesium content surface 201a of the magnesium-deficient layer 20a, and the magnesium-deficient layer 20a would disappear due to non-vacuum baking above 50° C., wherein the higher the temperature, the faster the rate of disappearance will be. Therefore, the magnesium-deficient layer 20a should have a thickness of at least >10 μm to be suitable for brazing. In addition, the surface reduction method can be non-heating thinning methods such as pickling, alkali cleaning, grinding, polishing, etching, or others, or other thinning methods under vacuum or a protective atmosphere or an inert atmosphere, such as plasma cleaning.

Further, the aluminum alloy M of this embodiment is a 6-series aluminum alloy with magnesium (Mg) element. Due to the Mg element, the 6-series aluminum alloy has higher strength than a 3-series or a 1-series aluminum alloy without Mg element (pure aluminum). Moreover, after softening by high temperature, the 6-series aluminum alloy can still be used to restore its strength and hardness by a heat treatment process. This structure would only slightly change the surface element concentration, and would not greatly affect the overall element content, which effectively maintains the original characteristics of 6-series aluminum alloys, such as to be able to be heat treated and have strong strength. This structure further makes the 6-series aluminum alloys have a low-magnesium surface similar to the 3-series and the 1-series aluminum alloys which have high brazeability.

It should be noted that the method and the alloy structure of the present disclosure can be applied to aluminum alloys as well as other magnesium-containing alloys. In addition, this method and alloy structure are not limited to the removing of the magnesium content, other elements that easily volatilize in the vacuum or accumulate on the alloy surface, such as zinc, are also applicable. In other words, the present disclosure can not only strengthen the brazeability of aluminum alloys, but can also be applied to other alloys that need to reduce easily oxidized solid solution elements on the surface, such as magnesium and zinc.

In conclusion, the alloy structure having a low magnesium content surface of the present disclosure includes an original magnesium-content layer and a magnesium-deficient layer formed on the alloy layer. Furthermore, the magnesium-deficient layer has a low magnesium content surface, which strengthens the brazeability of the alloy and improves the yield rate of the joint.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An alloy structure having a low magnesium content surface, comprising:
an original magnesium-content layer; and
a magnesium-deficient layer formed on the alloy layer,
wherein the magnesium-deficient layer has a low magnesium content surface.

2. The alloy structure having a low magnesium content surface according to claim 1, wherein the thickness of the magnesium-deficient layer is at least greater than 10 μm.

3. The alloy structure having a low magnesium content surface according to claim 1, wherein the original magnesium-content layer and the magnesium-deficient layer are made of a magnesium-containing aluminum alloy, and the magnesium content of the magnesium-deficient layer is less than the magnesium content of the original magnesium-content layer.

4. The alloy structure having a low magnesium content surface according to claim 1, wherein the low magnesium content surface of the magnesium-deficient layer is formed by removing the surface of the heat-treated aluminum alloy.
